(19) United States
(12) Patent Application Publication
(10) Pub. No.: US 2023/0390917 A1
(43) Pub. Date: Dec. 7, 2023

(54) Robot with workpiece support.

(71) Applicant: Matthew Phillip Truchinski, Adelanto, CA (US)

(72) Inventor: Matthew Phillip Truchinski, Adelanto, CA (US)

(21) Appl. No.: 17/804,933

(22) Filed: Jun. 1, 2022

(51) Int. Cl. B25J 9/00

(52) U.S. Cl. CPC B25J 9/0009

(57) ABSTRACT

A robot has three axis cable driven cartesian, gantry, positioner with additional fourth and fifth rotary axes. Multifunctional cnc machines use powered tools, stationary tools and a means to support material in one or more rotary axes to accurately machine or mark workpieces.

### SUMMARY

Computer numerically controlled equipment for plasma cutting, laser etching/cutting, machining, or other operations generally require a three axis cartesian positioner with an additional fourth “rotary” axes.

A preferred embodiment of the cnc machine tool is designed with the minimum cost components to provide a reasonably accurate and repeatable three axis positioner in addition to one or more rotary axes that provides motion and support for rotating tubular or beam profiles. This machine is intended, and not limited, to cnc machining, marking, etching, cutting, welding, or other operations on flat plates, sheets, irregular shaped parts, tubes, beams, channels.

Many cnc machines supply a spindle for a rotary axis, however, many do not have support mechanisms for profile workpieces. The competition might support only round profiles. This machine has room for two rotary axes configured for a four jaw chuck or a 3 jaw chuck and supports most profiles to 8″ in diameter.

This robot can be mounted horizontally or vertically. The main component is a cartesian coordinate gantry positioner with two rotary axes parallel to the X (horizontal) axis.

Vertical orientation allows sheets and plates to be mounted vertically to a workpiece subframe for a smaller machine footprint. This machine is intended for use in a standard 2 car garage. Vertical orientation allows more space for maneuvering around the machine, loading the machine, or, moving equipment around the machine.

Horizontal orientation, the conventional orientation for plasma cutters and routers, is also an option by adding leg assemblies to the 4896D base robot.

### BRIEF DESCRIPTION OF THE DRAWINGS

FIG. 1 is a right isometric view of the 4896D robot.

FIG. 1A is an exploded right isometric view of the 4896D robot.

FIG. 1B is a left orthographic view of the 4896D robot.

FIG. 1C is a front orthographic view of the 4896D robot.

FIG. 1D is a right orthographic view of the 4896D robot.

FIG. 2 is a right isometric view of 4896D robot.

FIG. 3A is an isometric view of the vertical axis assembly.

FIG. 3B is an isometric view of the upper horizontal carriage assembly.

FIG. 3C is an isometric view of the lower horizontal carriage assembly.

FIG. 4 is an isometric view of the driveshaft assembly.

FIG. 5A is an exploded isometric view of the YZ carriage weldment assembly.

FIG. 5B is an isometric view of the YZ carriage weldment.

FIG. 5C is a left isometric view of the YZ carriage with components.

FIG. 5D is a right isometric view of the YZ carriage with components.

FIG. 6A is a left isometric view of the 4896D robot.

FIG. 6B is a detail isometric view of the YZ carriage and Z axis.

FIG. 6C is a left isometric view of the Z axis assembly.

FIG. 7A is a left isometric view of the fourth axis drive assembly.

FIG. 7B is an exploded isometric view of the fourth axis drive assembly.

FIG. 8 is an isometric view of the three jaw chuck assembly.

FIG. 9 is an isometric view of the four jaw chuck assembly.

FIG. 10A is an isometric view of the translating rotary workpiece material support assembly.

FIG. 10B is an isometric view of the rotary workpiece material support assembly.

FIG. 100 is an exploded isometric view of the rotary workpiece material support assembly.

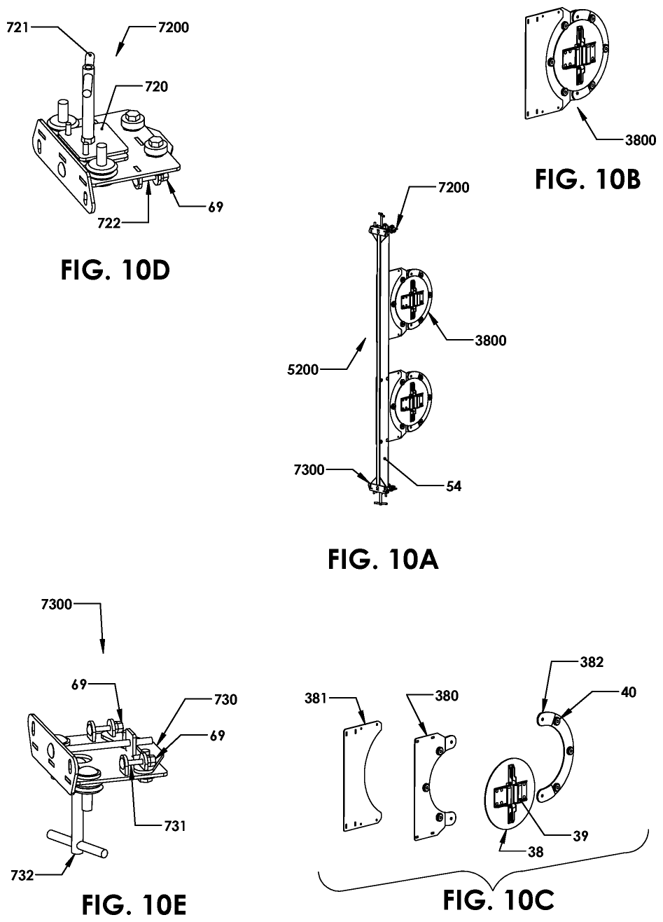

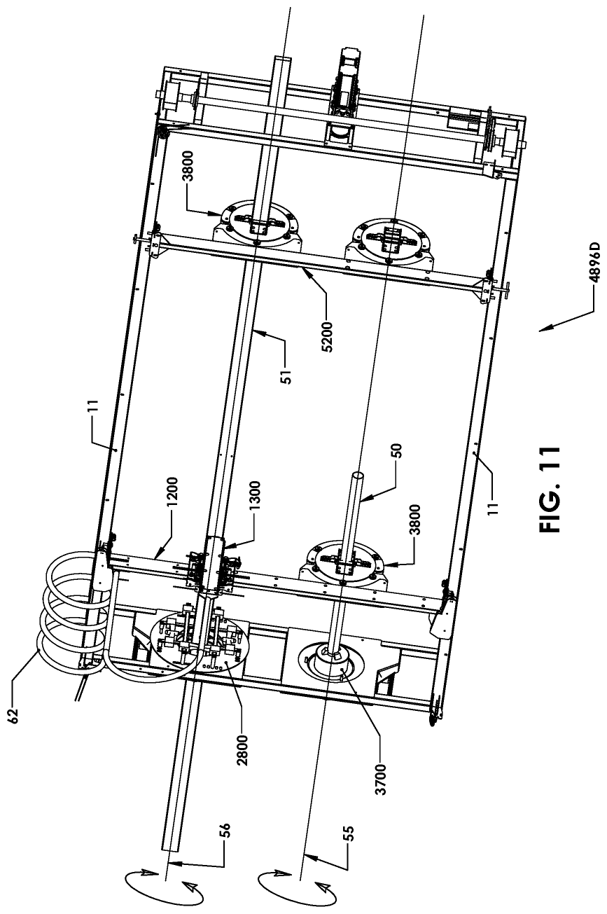

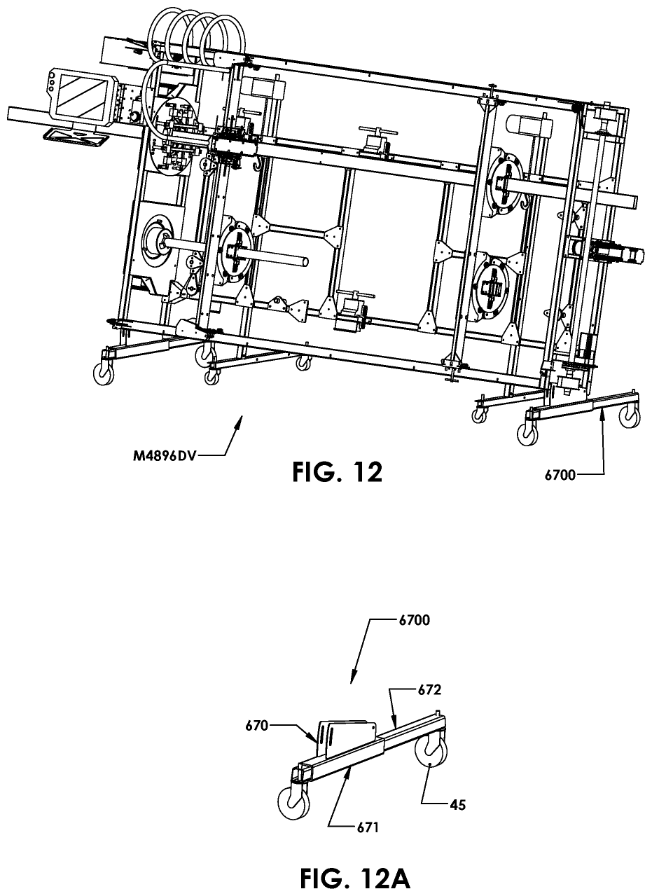

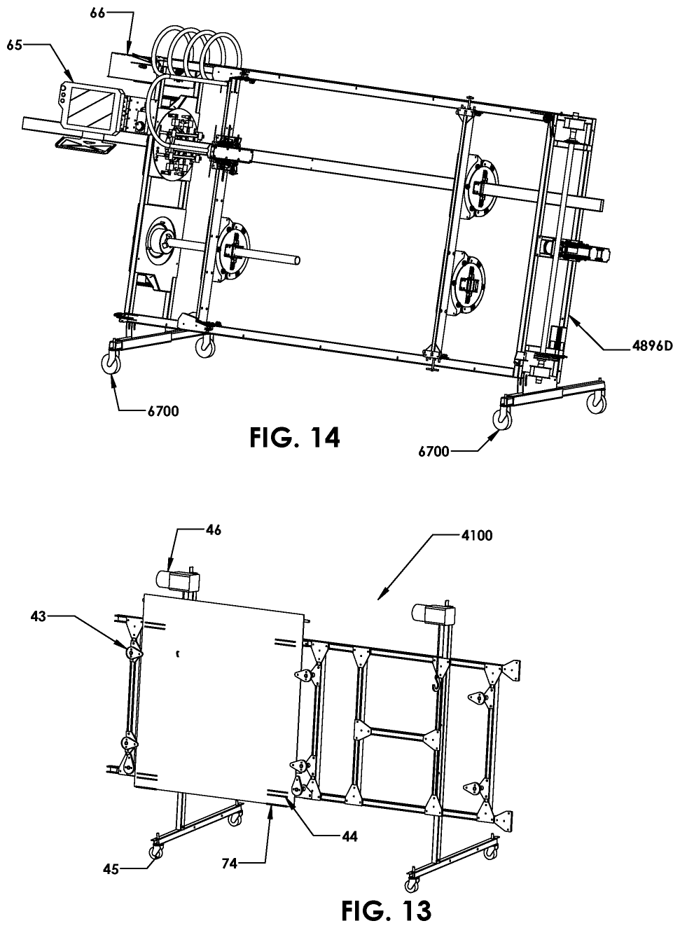

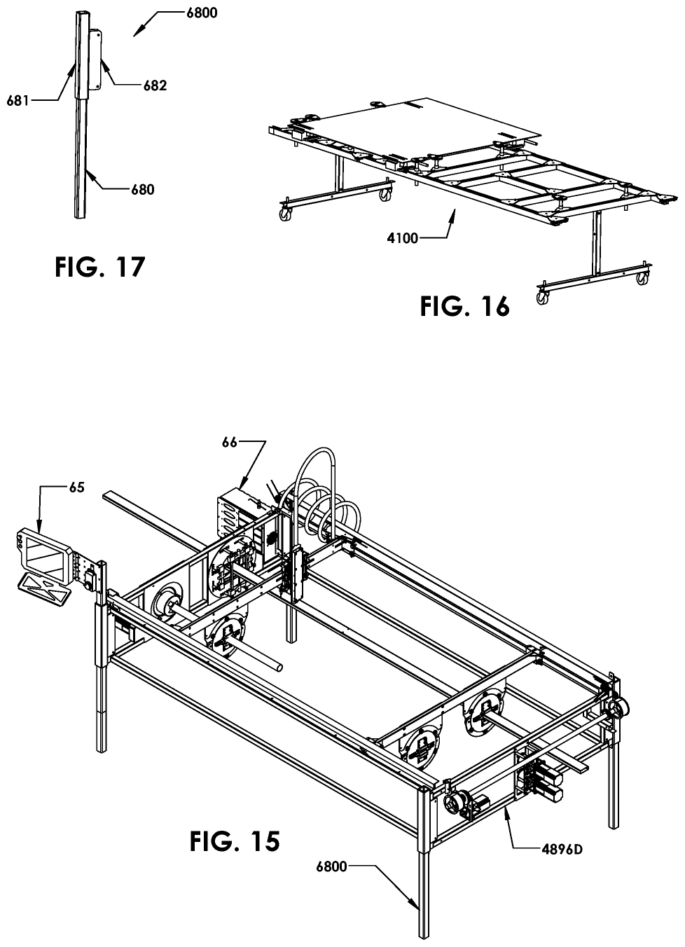

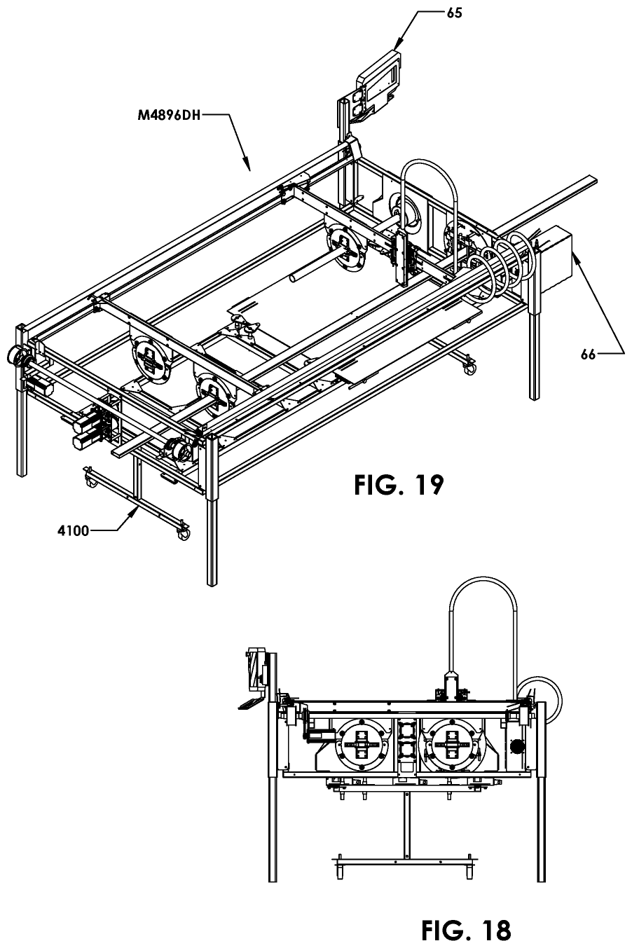

FIG. 10D is an isometric view of the translating material support upper carriage assembly.

FIG. 10E is an isometric view of the translating material support lower carriage assembly.

FIG. 11 is an right isometric view of the 4896D robot with sample rotary workpieces installed in the fourth and fifth axis.

FIG. 12 is a right isometric view of the M4896DV shown with the workpiece subframe in attached position.

FIG. 12A is a right isometric view of the leg assembly for the vertical machine.

FIG. 13 is a right isometric view of the flat workpiece subframe assembly.

FIG. 14 is a right isometric view of the M4896DV vertical oriented machine without sheet workpiece subframe assembly.

FIG. 15 is a left isometric view of the M4896DH horizontal machine without sheet workpiece subframe.

FIG. 16 is an isometric view of the sheet workpiece subassembly.

FIG. 17 is an isometric view of the leg assembly for horizontal machine.

FIG. 18 is a right horizontal view of the M4896DH horizontal machine with sheet workpiece subassembly attached.

FIG. 19 is an isometric view of the M4896DH machine with workpiece subassembly in working position (under the machine).

### DETAILED DESCRIPTION OF PREFERRED EMBODIMENTS

4896D (3 Axis Cartesian Gantry Robot with 4th and 5th Rotary Axis)

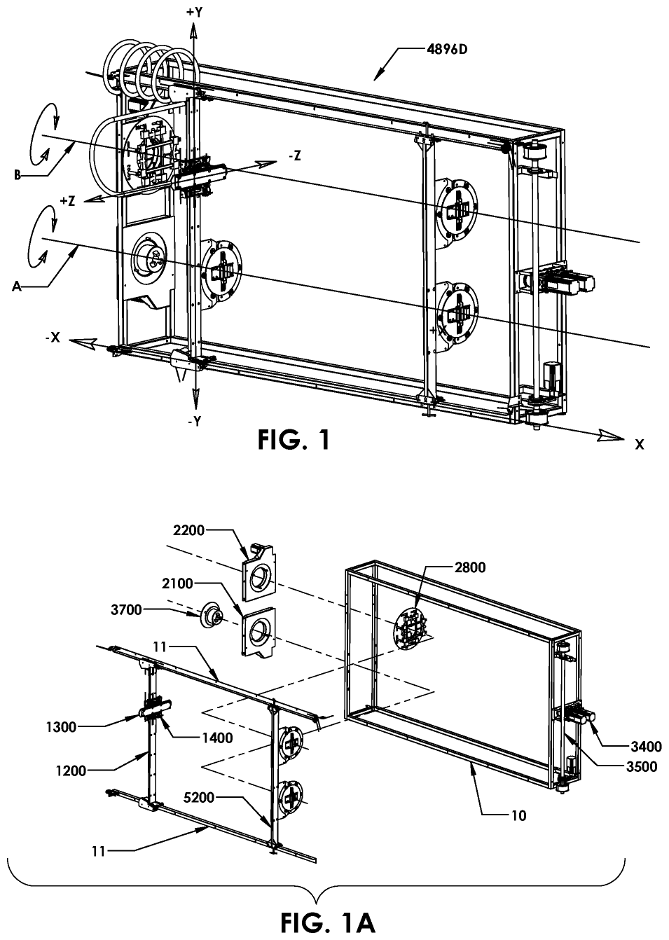

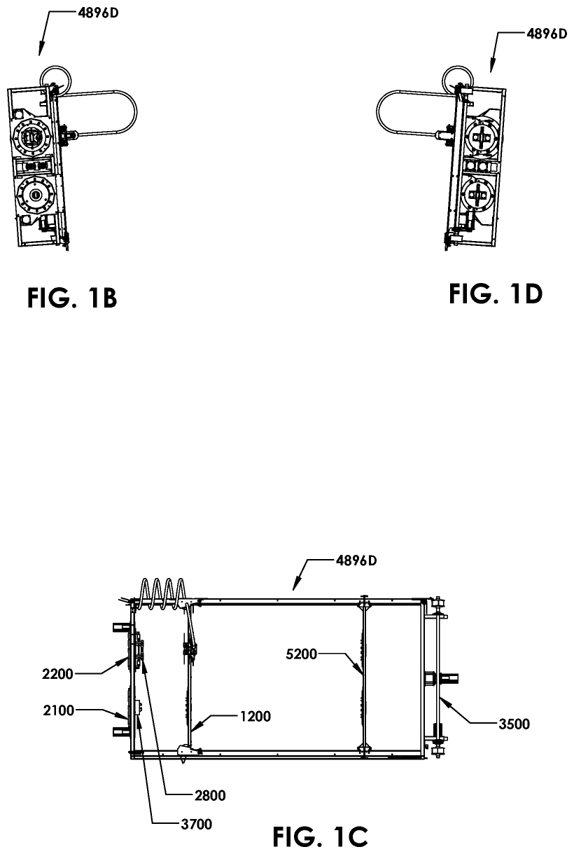

FIG. 1, shows an isometric view of the robot, in a cartesian coordinate system (X, Y, Z, A, B). −X to +X is the horizontal axis. −Y to +Y is the vertical axis. −Z to +Z is the z axis. A axis is the 4th “rotary” axis. B axis is the 5th “rotary” axis. A and B axes are parallel to the XY plane and parallel to the horizontal axis.

FIG. 1A, shows the robot includes a rectangular frame weldment 10 composed of metallic tubes in a horizontal and vertical orientation. Linear rails 11 are mounted horizontally to said frame weldment 10. A vertical axis 1200 is attached to the horizontal linear rails 11 via horizontal carriages 1500 & 1600. Z axis rail 1300 is connected to the vertical axis 1200 with a YZ carriage 1400. YZ Motors and Spools 3400, is mounted to weldment 10. Translating rotary support assembly 5200 is mounted to horizontal linear rails 11. A driveshaft/spool assembly 3500 is mounted to weldment 10.

FIG. 1B shows the left orthographic view of the 4896D robot.

FIG. 1C shows the front orthographic view of the 4896D robot.

FIG. 1D shows the right orthographic view of the 4896D robot.

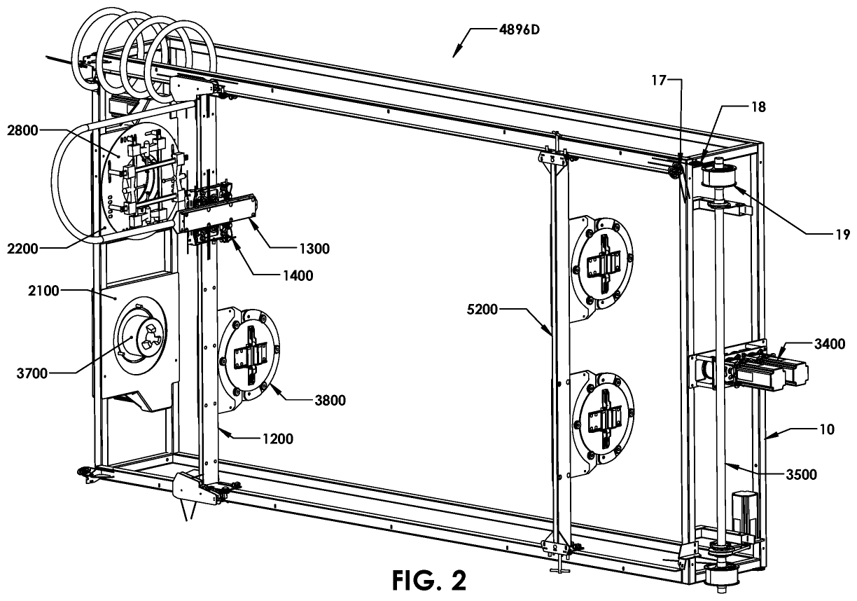

FIG. 2 shows YZ Motors and Spools 3400, attached to weldment 10. A fourth rotary drive assembly 2100 and fifth 2200 rotary drive assembly, or more, are attached to the machine with the axis in the X-Y plane parallel to the X axis linear rails 11.

FIG. 2 shows three jaw chuck assembly 3700 mounted to rotary drive assembly 2100.

FIG. 2 shows four jaw chuck assembly 2800 mounted to fifth axis rotary drive assembly 2200.

FIG. 2 shows the motor driven wire rope 17 (braided cable) is coupled between spools 19, and sets of idler pulleys 18 and the horizontal carriages on the vertical axis assembly 1200.

### Y Axis Assembly

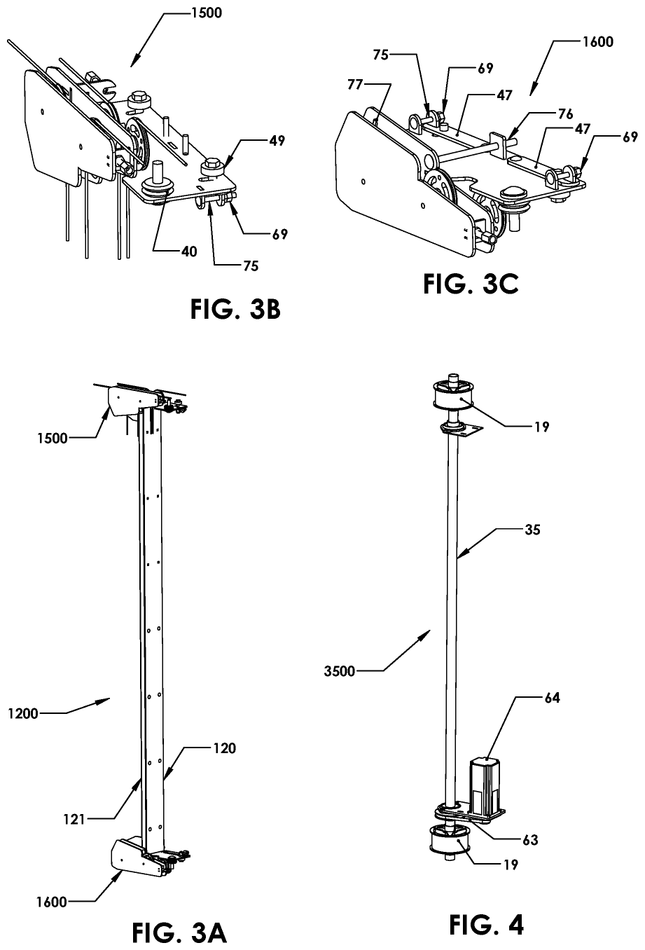

Referring to FIG. 3A, the Y axis assembly is comprised of a vertical beam 121 and vertical axis rail 120. Attached to the vertical axis beam are the horizontal carriage assemblies 1500 (FIG. 3B) and 1600 (FIG. 3C).

### Horizontal Carriages

Referring to FIGS. 3B & 3C, a rotating lever 47 is incorporated into the horizontal axis carriages 1500 and 1600 to allow means of adding compression, tightening nut 69, on bolt 75, to the linear rail 11 reacted by a V groove bearing 40 and X carriage lower bearing 49. Incorporated in the carriages is a Y Axis Square Pivot Bolt 76. Further restraining the vertical axis assembly to the horizontal carriages is slot 77 (FIG. 3C) where the assemblies are bolted together. This embodiment allows the vertical axis to be squared, (adjusted 90 degrees), to the X axis during the build and calibration process. The Y axis (square/perpendicularity to x axis) can be re-adjusted when needed.

### Driveshaft

A driveshaft/spool assembly 3500 (FIG. 4) is composed of a driveshaft 35 directly couples two spools 19. A timing belt 63 and motor 64 is attached to the driveshaft 35. Rotational movement of the motor 64 moves the vertical axis 1200 via tensile force on the wire rope 17. A preferred embodiment of this robot is that the X axis motor is mounted to the machine separate from the moving axis. This allows a lightweight, low moment of inertia, positioner driven by relatively inexpensive drive system.

### YZ Carriage

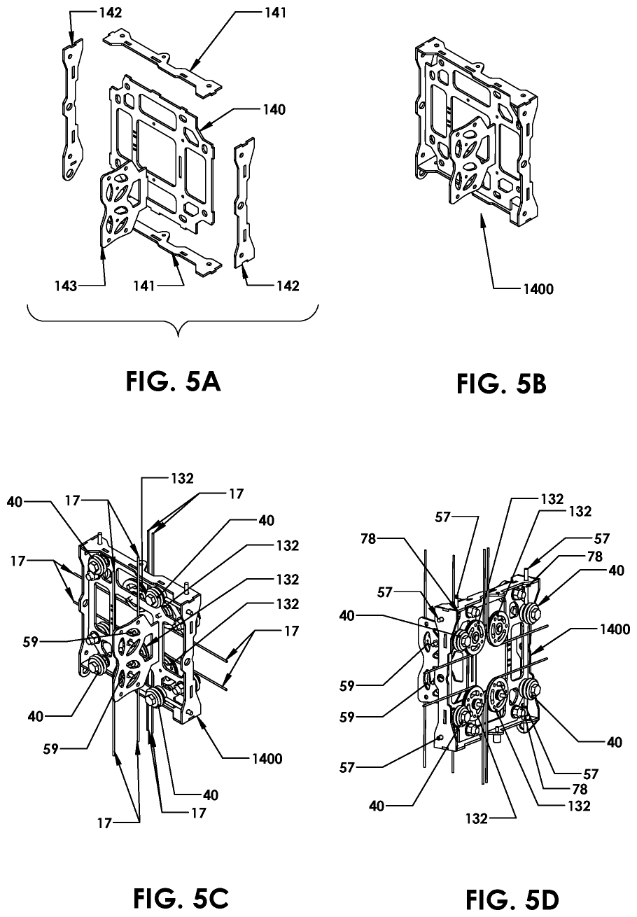

FIG. 5A shows an exploded view of the parts comprising the YZ carriage weldment 1400.

FIG. 5B shows a left isometric view of the welded YZ carriage 1400,

FIG. 5C shows Y idler pulleys 59, Z idler pulleys 132 with a wire rope 17. Tension in

the wire rope 17, controls position of the YZ carriage 1400.

FIG. 5D shows a right isometric view of the YZ carriage with components. Rotating YZ carriage compression nuts 78 resisted by YZ carriage weldment 1400 adds compression to the z head assembly bearings.

A preferred embodiment of the invention is a YZ carriage that allows movement of the Y and Z axis with one YZ carriage 1400 without a motor mounted to the Z head assembly.

### Z Positioner

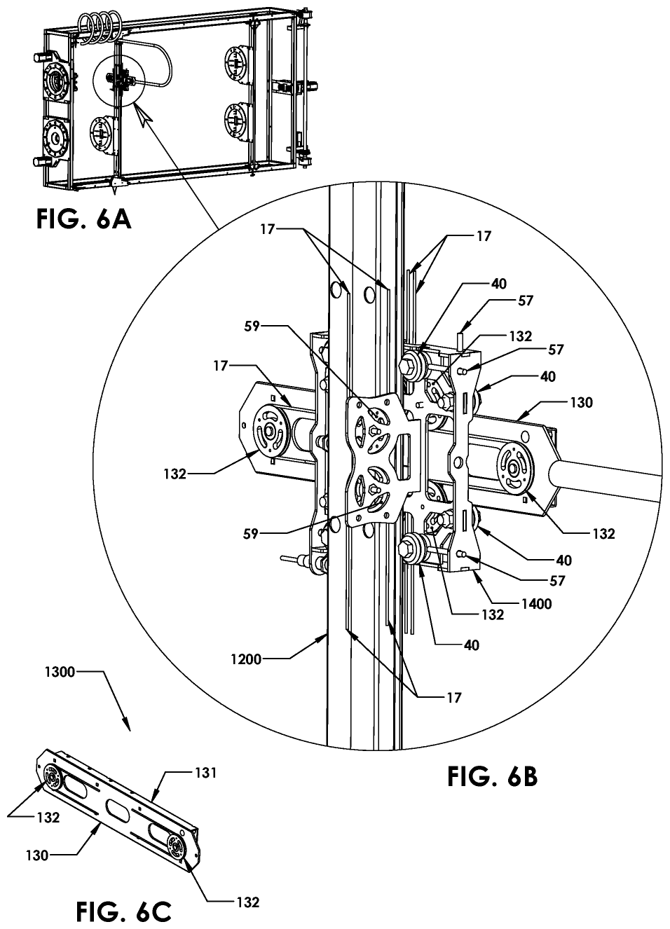

FIG. 6A shows a left isometric view of the 4896D robot.

Referring to FIG. 6B, the YZ carriage 1400 contains four Z idler pulleys 132 to supply the reaction force to the Z idler pulleys 132 in the Z axis while restrained with the wire rope 17 (braided cable) to control Z axis position. The Vertical axis position is determined by the force in the wire rope 17 in the two Y idler pulleys 59 mounted vertically. The embodiment of this design arrangement allows for a compact, lightweight, motorless Z head assembly 1300 (robot positioner). YZ carriage compression adjuster eye bolt 57 attached to axis of V groove bearing 40 and translating inside oblong in YZ carriage weldment 1400. V Groove bearings 40 provide compressive force to Z axis rail 130. A preferred embodiment of this design is that eye bolt 57 provides a low cost, lightweight, mechanism for applying compressive force against the rail and opposite v groove bearing eliminating play in the carriage rail system and a mechanism for adjusting square (orthogonality of the Z axis to the XY plane) of the Z axis relative to the Y axis.

FIG. 6C is a view of the Z axis assembly 1300. The assembly is composed of a beam 131 attached to linear rail 130. Idler pulleys 132 are attached at each end.

### Rotary Drive Assemblies

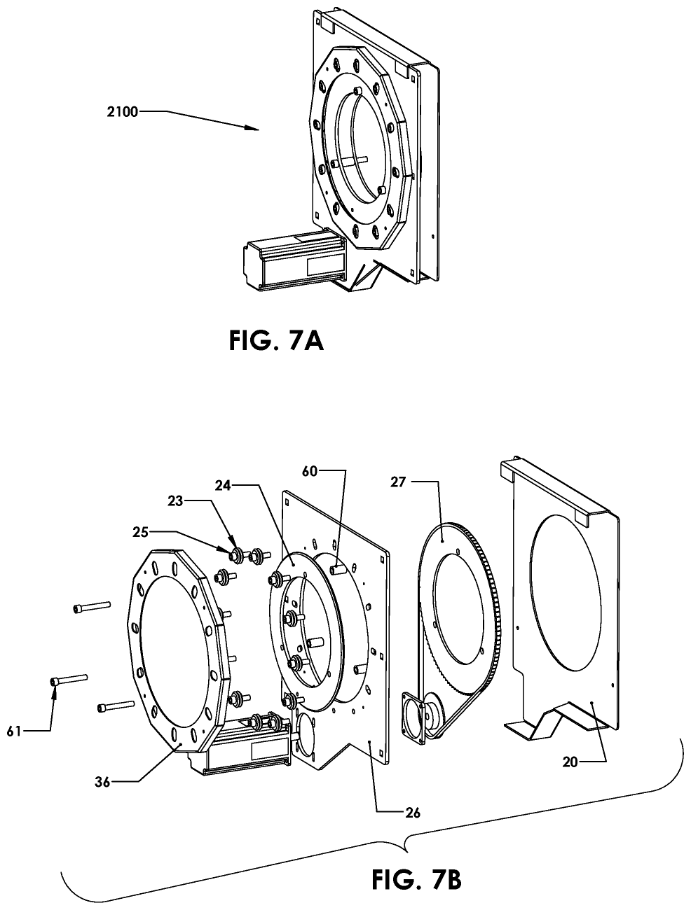

FIG. 7A is an assembled isometric view of the rotary drive unit. Rotary drive assemblies provide the rotational force and support to position a rotary workpiece in the machine. A machine tool must be able to repeatably move to a known position on a workpiece without the workpiece flopping around inside the machine. The drive unit provides the rotational force and support for the left side of the rotary workpiece. This drive unit may be redesigned and repositioned for different size workpieces.

FIG. 7B is an exploded isometric view of the rotary drive unit. Bolts 25 contain a planetary set of bearings 23, a spindle ring 24 and compress against a base plate 26. A sprocket 27 is mounted to the said spindle ring 24 using bolts 61 and spacers 60. The preferred embodiment of this design is that this design allows a workpiece up to 8″ in diameter to be translated through the chuck. Workpieces up to 20′ long, or longer, may be introduced to the machine for cnc operations.

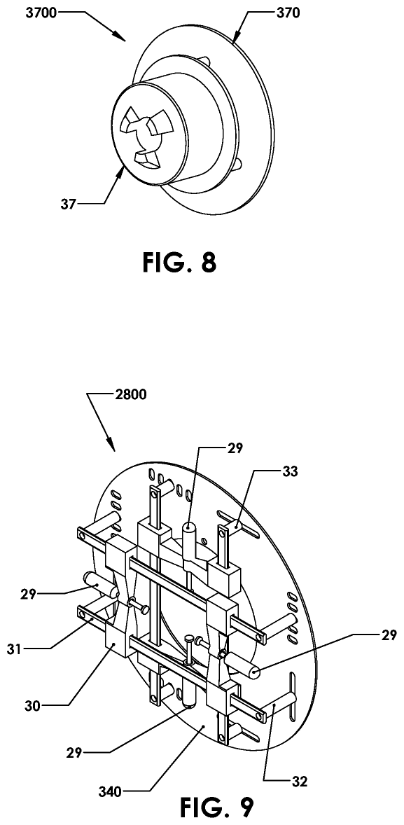

FIG. 8 shows a three jaw chuck 3700, for smaller size parts and fixtures.

FIG. 9 shows a four jaw chuck assembly 2800, for larger size profiles. Indicating a workpiece profile in alignment with the fourth axis requires the use of threaded handles 29, translating locking stops 30 along a chuck rail 31. The chuck rail 31 is spaced away from the four jaw chuck base ring 340 using long spacers 32 and short spacers 33.

A preferred embodiment of the invention is that the machine is capable of performing operations on various profile sizes requiring different chucks without requiring chuck tooling changeovers.

FIG. 10A shows the translating rotary workpiece support assembly 5200. This assembly supports the right side of a rotary workpiece for the purpose of aligning and supporting the workpiece along a rotary axis. This assembly translates on the horizontal rails, (X axis), of the gantry robot and at the same time allows rotational support of the workpiece. This assembly must translate on the horizontal axis to support the ends of various length workpieces.

FIG. 10B shows the Rotary workpiece support assembly 3800. This assembly may be bolted to the vertical axis assembly 1200 to support rotary workpieces.

FIG. 100 shows the Rotary workpiece support assembly 3800 is composed of an insert 38 that rotates about a planetary set of bearings 40. Inserts 38 are custom manufactured for each profile. Inserts 38 provide support for the workpiece profile to rotate precisely on center of rotation of the rotary axis. A preferred embodiment of this robot is the rotating inserts for supporting the workpiece material along the rotating axis. These inserts allow I beams, C channels, rectangles and square profile workpieces to be supported and rotated in a rotary axis.

FIG. 10D shows caliper pad 720 for the rotating material support assembly 5200.

Tightening t nut 721 fixes the translating rotating material support assembly along the horizontal axis. Tightening nut 69 adds compression between the carriage assembly 7200 and horizontal rail 11.

FIG. 10E shows the lower carriage assembly for the translating rotating material support assembly 5200. Tightening nut 69 adds compression between the carriage assembly 7300 and horizontal rail 11.

Translation Rotary Support Assembly

FIG. 11 shows the translating rotary support assembly 5200 translates along the horizontal linear rails 11 supporting workpieces along the rotary axes centers of rotation 55 and 56 via carriages 7200 and 7300 (carriages shown in FIG. 10A).

### 3800 Mounted to Y Axis

FIG. 11 shows Rotary workpiece support assembly 3800 is mounted to the vertical axis 1200. The embodiment of this arrangement allows a short piece of stock 50 to be supported in the fourth axis center of rotation 55 to cut short parts from the right side of the workpiece 50. (short parts are parts less than a few inches).

### Rectangular Workpiece Four Jaw Chuck.

FIG. 11 shows a sample rectangular workpiece 51 is supported by the four jaw chuck 2800 on the left side and supported on the right side by Rotary workpiece support assembly 3800 on the translating rotary support assembly 5200. The embodiment of this arrangement allows features to be cut in a longer rotary workpiece 51.

### Festoon

FIG. 11 shows a hose/wire festoon 62 is mounted to the frame weldment 10 to allow the connection of communication cables, hoses, torches, and various machine tools located on the Z axis assembly 1300. A cable duct may connect between the festoon and the Z head (positioner). A preferred embodiment of this robot is a low cost cable and hose festoon to manage cables and hoses from the welded frame 10, to the gantry positioner 1300.

### Vertical Machine (M4896DV)

The machine can be configured for vertical bed orientation as shown in FIG. 12.

This figure shows the robot with the leg assemblies 6700 and the sheet workpiece subassembly 4100 attached.

A vertical leg assembly 6700 is shown in FIG. 12A. The leg assemblies 6700 support the machine vertically or slightly angled from vertical. The embodiment of this design orientation allows a smaller footprint and transportable machine.

### Workpiece Subassembly

A detachable workpiece subframe assembly 4100 (FIG. 13) is mounted to the rear of the machine. This subframe holds sheets, plates, parts, fixtures. Wheels 45 may be mounted to the subframe to allow independent movement, loading and unloading material, separate from the robot. Winches 46 are mounted to the workpiece subframe assembly 4100 to assist in the loading of heavy workpieces.

FIG. 13 shows sheet workpiece support 74 holding sample sheet workpiece in a vertical orientation. Magnetic blocks 44 are added to the workpiece subframe to hold magnetic sheets, plates, parts in place while performing cnc operations.

Mechanical clamps 43 (FIG. 13) may be added to hold non magnetic sheets and parts. A preferred embodiment of this robot the robot has the option of loading workpieces independent of the machine (while machine in operation with another workpiece), then the cart fixed into position in the machine. This would allow quicker material changeover times and the possibility to add welding fixtures for assemblies of parts for repeat tasks.

FIG. 14 shows the M4896DV machine without the detachable workpiece subassembly 4100. The machine may use the rotary axes without the workpiece subassembly 4100 attached.

FIG. 14 shows a computer and touchscreen display 65 sends electronic signals to the motor control enclosure 66. Motor control unit supplies power to motors.

### Horizontal Machine (M4896DH)

The machine can be configured for horizontal bed orientation as shown in FIG. 15. A computer and touchscreen display 65 sends electronic signals to the motor control enclosure 66. Motor control unit supplies power to motors.

The detachable workpiece subassembly 4100, is shown in FIG. 16, is for holding sheets, parts, or fixtures of parts and assemblies. This assembly may be bolted to the robot to prevent movement between robot and workpiece. Plates or sheets may be added to the workpiece subassembly. It is possible to clamp the workpiece with mechanical clamps or magnetic blocks or let gravity hold the material in place.

FIG. 17 shows Leg Assemblies for horizontal machine 6800 are mounted on the corners of the 4896D robot to provide traditional orientation for most cnc routers and plasma tables.

FIG. 18 is a right orthographic view of the M4896DH “horizontal” machine with detachable workpiece subassembly 4100 attached.

FIG. 19 shows and isometric view of the M4896DH, horizontal machine with attached workpiece subassembly 4100.

What is claimed is:

1. A robot comprising:
a frame,
a three axis gantry positioner,
a means to rotate workpieces (round, square, rectangular, angles, channels and other rotary workpieces) in one, or more, rotary axes,
a means to support workpieces (round, square, rectangular, angles, channels and other rotary workpieces) along one, or more, rotary axes,
wherein motor driven wire ropes moves a gantry positioner in a cartesian coordinate motion system.

2. The robot according to claim 1, further comprises rotating inserts to support rotation of the workpiece material along the rotary axes supported by planetary bearings.

3. The robot according to claim 2, further comprises a planetary set of bearings for supporting the spindle ring in the rotary axis.

4. The robot according to claim 1, further comprises an YZ carriage weldment allowing simultaneous movement of the vertical and Z axis without a motor mounted to Z head assembly.

5. The robot according to claim 4, further comprises idler pulleys mounted to the YZ carriage, idler pulleys on the Z axis, used in conjunction with a wire rope (braided cable) to control Z position of the robot with the Z motor mounted to the frame weldment.

6. The robot according to claim 1, further comprises carriages with pivot bolts to allow squaring of the Y axis 90 degrees relative to the X axis.

7. The robot according to claim 1, further comprises an option of adding leg assemblies to orient machine horizontal or vertical positions.

8. The robot according to claim 1, further comprises a detachable subframe for supporting workpieces (sheets, plates, fixtures, parts, vices, magnets).

9. The robot according to claim 8, further comprises winches for loading material onto workpiece subframe.

10. The robot according to claim 9, further comprises mechanical clamping elements for holding material to subframe.

11. A robot comprising:
a frame,
a three axis gantry positioner,
a means to support sheets, plates, parts, fixtures,
a means to rotate workpieces along one or more rotary axes,
a means to support workpieces along one or more rotary axes,
wherein motor driven spools apply tension to wire ropes, moves a gantry positioner in a cartesian coordinate motion system.

12. The robot according to claim 11, further comprises two, or more, rotary axes parallel to the horizontal axis, wherein tubular profiles or beam workpiece(s) are supported and driven on rotating axes.

13. The robot according to claim 12, further comprises rotating inserts to support rotation of the workpiece material along the rotary axes supported by planetary bearings.

14. The robot according to claim 13, further comprises a planetary set of bearings for supporting the spindle ring in the rotary axis.

15. The robot according to claim 11, further comprises an YZ carriage weldment allowing simultaneous movement of the vertical and Z axis without a motor mounted to Z head assembly.

16. The robot according to claim 15, further comprises idler pulleys mounted to the YZ carriage, idler pulleys on the Z axis, used in conjunction with a wire rope (braided cable) to control Z position of the robot with the Z motor mounted to the frame weldment.

17. The robot according to claim 11, further comprises carriages with pivot bolts to allow squaring of the Y axis 90 degrees relative to the X axis.

18. The robot according to claim 11, further comprises an option of adding leg assemblies to orient machine horizontal or vertical positions.

19. The robot according to claim 11, further comprises a detachable subframe for supporting workpieces (sheets, plates, fixtures, parts, vices, magnets).

20. The robot according to claim 19, further comprises winches for loading material onto workpiece subframe.
